(19) United States
(12) Patent Application Publication
(10) Pub. No.: US 2013/0039224 A1
(43) Pub. Date: Feb. 14, 2013

(54) FORWARDING OF TELECOMMUNICATION CALLS AND MESSAGES

(71) Applicants: Oleksandr Yegorov, Kharkiv (UA); Volodymyr Fedosieiev, Kharkov (UA); Peter Kulakov, Kharkov (UA)

(72) Inventors: Oleksandr Yegorov, Kharkiv (UA); Volodymyr Fedosieiev, Kharkov (UA); Peter Kulakov, Kharkov (UA)

(73) Assignee: ECHOSTAR UKRAINE, L.L.C., Kharkiv (UA)

(21) Appl. No.: 13/635,855

(22) PCT Filed: Mar. 25, 2010
(86) PCT No.: PCT/UA2010/000013

§ 371 Date: Oct. 25, 2012

(51) Int. Cl. H04L 12/16

(52) U.S. Cl. 370/259

(57) ABSTRACT

An apparatus for place-shifting telecommunication messages is presented. The apparatus includes a telecommunication service interface compatible with a telecommunication network that provides telecommunication service to the apparatus, and a network interface compatible with a data communication network that provides data connectivity between the apparatus and a remote user device. The apparatus also includes a data network conversion module and a telecom network conversion module. The data network conversion module is coupled between the telecommunication service interface and the network interface, and the telecom network conversion module is configured to convert local telecommunication signals received by the telecommunication service interface into a first format compatible with the data communication network. The telecom network conversion module is coupled between the network interface and the telecommunication service interface, and the telecom network conversion module is configured to transform remote network data received by the network interface into a second format compatible with the telecommunication network.

### TECHNICAL FIELD

Embodiments of the subject matter described herein relate generally to telecommunication systems and methodologies. More particularly, embodiments of the subject matter relate to the use of a place-shifting device that handles telecommunication calls and/or messages with a remote user device.

### BACKGROUND

Most television viewers now receive their video signals through a content aggregator such as a cable or satellite television provider. Digital video broadcasting (DVB) systems, such as satellite systems, are generally known. A DVB system that delivers video service to a home will usually include a video services receiver system or device, which is commonly known as a set-top box (STB). In the typical instance, encoded television signals are sent via a cable or wireless data link to the viewer's home, where the signals are ultimately decoded in the STB. The decoded signals can then be viewed on a television or other appropriate display as desired by the viewer. Some modern STBs are web-enabled devices that have Internet connectivity to provide enhanced features. Moreover, some modern STBs are provided with standard telephone jacks, plugs, or ports that allow those STBs to be connected to the local telephone network. Connectivity with the local telephone network in this manner enables these STBs to support certain telephone features, such as placing or answering calls using the local telephone line.

### BRIEF SUMMARY

An exemplary embodiment of a method of place-shifting telecommunication messages is provided. The method involves receiving an incoming telecommunication message at a place-shifting device, and encoding the incoming telecommunication message for transmission compatibility with a data communication network, resulting in an encoded telecommunication message. The method also obtains a network identifier of a remote user device. The method continues by providing the encoded telecommunication message to the data communication network, using the network identifier for routing guidance.

Also provided is an exemplary embodiment of a method of place-shifting telephone calls that involve a traditional landline telephone number. This method may begin by maintaining, with a place-shifting device residing at a location associated with the traditional landline telephone number, a communication link between a local telephone network and a data communication network. The local telephone network supports service for the traditional landline telephone number, and the data communication network provides data connectivity with a remote user device. For communication from the local telephone network to the remote user device, the method converts telephone signals into a first format compatible with transmission over the data communication network, wherein the conversion is performed by the place-shifting device. For communication from the remote user device to the local telephone network, the method converts voice-conveying data into a second format compatible with transmission over the local telephone network, wherein the conversion is performed by the place-shifting device.

An exemplary embodiment of an apparatus for place-shifting telecommunication messages is also provided. The device includes: a telecommunication service interface compatible with a telecommunication network that provides telecommunication service to the apparatus; a network interface compatible with a data communication network that provides data connectivity between the apparatus and a remote user device; a data network conversion module coupled between the telecommunication service interface and the network interface; and a telecom network conversion module coupled between the network interface and the telecommunication service interface. The data network conversion module is configured to convert local telecommunication signals received by the telecommunication service interface into a first format compatible with the data communication network, and the telecom network conversion module is configured to transform remote network data received by the network interface into a second format compatible with the telecommunication network.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram of an embodiment of a telecommunication place-shifting system;

FIG. 2 is a schematic representation of a place-shifting apparatus suitable for use in the system depicted in FIG. 1;

FIG. 3 is a schematic functional representation of the place-shifting apparatus shown in FIG. 2; and

FIG. 4 is a flow chart that illustrates an exemplary embodiment of a telecommunication place-shifting process.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks; and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

Recently, consumers have expressed significant interest in place-shifting devices that allow viewing of television or other video content at locations other than their primary media presentation device. Place-shifting devices typically packetize video content that can be transmitted over a local or wide area network to a portable computer, mobile phone, personal digital assistant, remote television or other remote device capable of playing back the packetized media stream for the viewer. Place-shifting therefore allows consumers to view their media content from remote locations such as other rooms, hotels, offices, and/or any other locations where portable media player devices can gain access to a wireless or other communications network.

The system and methods described herein relate to the place-shifting of telecommunication messages (such as telephone calls) from a traditional landline telephone location to a remote user device. In certain embodiments, the place-shifting of telecommunication messages is carried out using a suitably configured place-shifting device or apparatus that resides at or near the location that is associated with a traditional landline telephone number. The place-shifting device functions to convert the telecommunication signals (received from the landline service in an analog or digital form) into a format that is suitable for transmission over a data communication network such as the Internet. In practice, the place-shifting apparatus could be realized as a video services receiver system (e.g., a set-top box that can also be used to receive cable or satellite television service). Thus, the place-shifting apparatus can be used to place-shift telephone calls, videoconference calls, email, text messages, and other telecommunication messages from the user's home to a remote user device, which need not be located in the user's home.

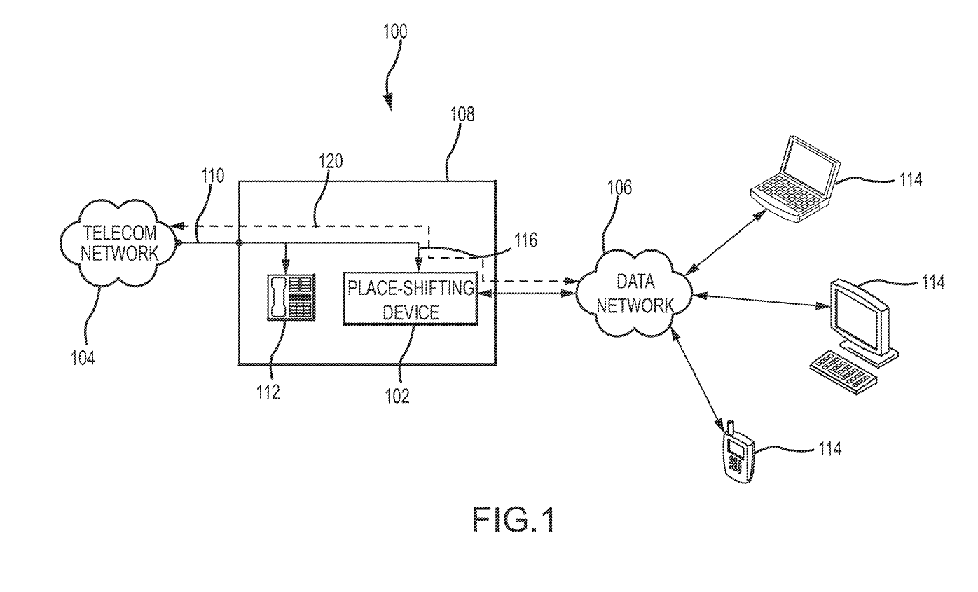

FIG. 1 is a diagram of an exemplary embodiment of a telecommunication place-shifting system 100 that supports the place-shifting of telecommunication messages. The place-shifting system 100 is based upon a suitably configured and deployed place-shifting device 102 that serves as an interface, conversion, and/or transformation component between at least one local telecommunication (“telecom”) network 104 and at least one data communication network 106. Although not required in all embodiments, FIG. 1 depicts the place-shifting device 102 residing at a location 108 such as a house or other dwelling, an office space, a building, or any other type of structure. This location 108 may be associated with a traditional landline telephone number, e.g., a local telephone number assigned to a household. In this regard, the landline telephone number is used to provide analog and/or digital telecommunication services to the location 108 (or to a relatively small area that includes the location 108 if a short-range cordless telephone device is used). Thus, the landline telephone number does not normally support long-range wireless telephones such as cellular telephone handsets.

The local telecommunication network 104 provides and supports traditional landline telecommunication services to the location 108 via a subscriber line 110 (which may also be referred to as a local loop, a local connection, or a local link). More specifically, the local telecommunication network 104 provides and supports telephone service for at least one traditional landline telephone number assigned to the location 108. In this regard, the local telecommunication network 104 may include a public switched telephone network (PSTN), as is well understood by those familiar with telecommunication systems. As is well understood, the local telecommunication network 104 could be utilized to provide analog telephone service or digital telephone service to the location 108. Moreover, although not depicted in FIG. 1, the local telecommunication network 104 may cooperate with any number of other telecommunication, telephone, and/or data communication networks, including, without limitation, cellular networks, cable or satellite service provider networks, the Internet, or the like. In certain embodiments, at least one traditional telephone device 112 (cordless or conventional) is coupled to the subscriber line 110 for purposes of placing and receiving calls using the landline telephone number assigned to the location 108. For this exemplary embodiment, the place-shifting device 102 is also coupled to the subscriber line 110 such that it can also be used to support telecommunication services associated with the landline telephone number assigned to the location 108. Accordingly, the local telecommunication network 104 also provides and supports telecommunication service for the place-shifting device 102.

The data communication network 106 provides and supports data connectivity with at least one remote user device 114. More particularly, the data communication network 106 is used to establish and maintain data communication between the place-shifting device 102 and the remote user device(s) 114. In practice, the data communication network 106 may be any digital or other communications network capable of transmitting messages or data between senders (e.g., the place-shifting device 102) and receivers (e.g., the remote user device(s) 114). In certain embodiments, the data communication network 106 includes a packet switched network that facilitates packet-based data communication, addressing, and data routing. The packet switched network could be, for example, a wide area network, the Internet, or the like. In various embodiments, the data communication network 106 includes any number of public or private data connections, links or networks supporting any number of communications protocols. The data communication network 106 may include the Internet, for example, or any other network based upon TCP/IP or other conventional protocols. In various embodiments, the data communication network 106 could also incorporate a wireless and/or wired telephone network, such as a cellular communications network for communicating with mobile phones, personal digital assistants, and/or the like. The data communication network 106 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol.

A remote user device 114 is “remote” in that it need not be geographically limited or restricted to the location 108. In some scenarios, a remote user device 114 is portable and mobile in nature, such that it can be operated in a remote manner, relative to the location 108 and relative to the subscriber line 110. In other implementations, a remote user device 114 could be a relatively stationary device (such as a desktop computer) that is positioned at a geographically remote location, relative to the location 108 and relative to the subscriber line 110. Depending upon the particular embodiment, a remote user device 114 may be implemented as any of the following device types, without limitation: a wireless telephone such as a cellular phone; a network telephone; a portable computer; a desktop computer; a personal digital assistant; a digital media player; a video game system; a remote control device; a medical device; a vehicle-based communication, navigation, or entertainment system; or audiovisual equipment. The specific data communication protocols, data communication methodologies, and data communication interfaces utilized by the remote device(s) 114 may vary from one embodiment to another, depending upon the particular manner in which the remote device(s) 114 are realized.

As mentioned previously, the place-shifting system 100 can be utilized to carry out place-shifting of telecommunication messages from the location 108 to a remote user device 114. It should be appreciated that a telecommunication message need not be limited to a two-way telephone call. Indeed, a telecommunication message or a telecommunication session handled by the place-shifting device 102 may include, without limitation: a voice call; an email; a text message; an image-containing message; a video-containing message; an instant message; a videoconference call; or the like. In practice, a telecommunication message could include a combination of information or data types. For instance, a telecommunication message could convey text, images, audio, and/or multimedia content (such as an HTML or an XML document). In certain embodiments, the place-shifting device 102 serves as a converting interface for telecommunication messages communicated between the telecommunication network 104 and the data communication network 106. This particular embodiment of the place-shifting device 102 is suitably configured to receive incoming telecommunication message content 116 from the telecommunication network 104 (where such content may be conveyed using analog or digital transmission techniques), convert the received content into a streaming format, and then transmit the encoded media stream to at least one of the remote user devices 114 over the data communication network 106. The remote user device 114 receives the encoded media stream, decodes the stream, and presents the decoded telecommunication message content to the user in an appropriate format (and, preferably, with little to no detectable transmission latency that would otherwise adversely influence voice quality). In various embodiments, a server (not shown) may also be provided to communicate with the place-shifting device 102 and/or the remote user device 114 via the data communication network 106 to assist these devices in locating each other, maintaining security, providing or receiving content or information, and/or any other features as desired. This feature is not required in all embodiments, however, and the concepts described herein may be deployed in any data communication application or environment, including place-shifting but also any other media or other data streaming situation.

The place-shifting device 102 may be realized as any component, hardware, software logic and/or the like capable of performing the functions and operations described herein. In various embodiments, the place-shifting device 102 may incorporate suitable encoder, decoder and/or transcoder logic to convert telecommunication messages or other media content into a packetized format that can be transmitted over the data communication network 106. As described above, the telecommunication message content may be received in an appropriate format from the local telecommunication network 104. In practice, an embodiment of the place-shifting device 102 may be integrally implemented in, or realized, as, a video services receiver system of a cable or satellite television system. In other embodiments, the place-shifting device 102 could be implemented using any of the various SLINGBOX products available from Sling Media of Foster City, Calif., although other products could be used in other embodiments. For example, the place-shifting device 102 may be realized as a hybrid set-top box (STB) or other receiver that also provides transcoding and place-shifting features. Such a hybrid device may receive satellite, cable, broadcast and/or other signals that encode television programming or other content received from an antenna, modem, server and/or other source. A receiver of the place-shifting device 102 may further demodulate or otherwise decode received video signals to extract programming that can be locally viewed and/or place-shifted to the remote user device(s) 114 as appropriate. In this regard, the place-shifting device 102 may also include a content database stored on a hard disk drive, memory, or other storage medium to support a personal or digital video recorder (DVR) feature or other content library as appropriate.

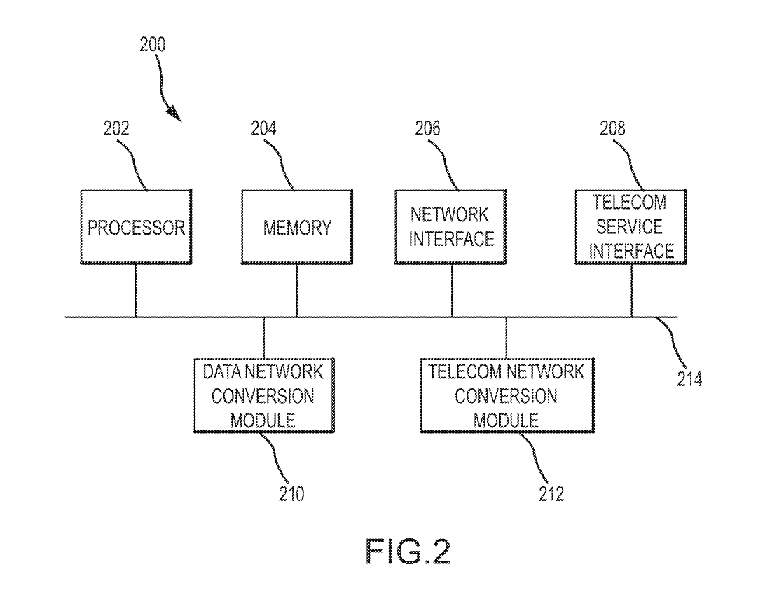

FIG. 2 is a schematic representation of a place-shifting apparatus 200 suitable for use in the place-shifting system 100 depicted in FIG. 1. As mentioned previously, the place-shifting apparatus 200 may be realized as an STB, a video services receiver, or other piece of equipment. The illustrated embodiment of the place-shifting apparatus 200 includes, without limitation: at least one processor 202; an appropriate amount of memory 204; a network interface 206; a telecommunication service interface 208; a data network conversion module 210; and a telecom network conversion module 212. These components and elements may be coupled together as needed for purposes of interaction and communication using, for example, an appropriate interconnect arrangement or architecture 214. It should be appreciated that an embodiment of the place-shifting apparatus 200 may include additional elements and features that support conventional functions and operations. For instance, the place-shifting apparatus 200 could include one or more user interface elements that allow the user to control settings, preferences, and options related to the place-shifting apparatus 200, and/or as otherwise needed to operate the place-shifting apparatus 200.

The processor 202 may be implemented with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. In particular, the processor 202 may be realized as a microprocessor, a controller, a microcontroller, or a state machine. Moreover, the processor 202 may be implemented as a combination of computing devices, e.g., a combination of a digital signal processor and a microprocessor, a plurality of microprocessors, one or more microprocessors in conjunction with a digital signal processor core, or any other such configuration.

The memory 204 may be provided by one or more devices, elements, modules, or the like. In this regard, the memory 204 may be realized as RAM memory, flash memory, EPROM memory, EEPROM memory, registers, a hard disk, a removable disk, or any other form of storage medium known in the art. In certain embodiments, the memory 204 includes or is realized as a hard disk, which may also be used to support integrated DVR functions if the place-shifting apparatus 200 is realized as a video services STB. The memory 204 can be coupled to the processor 202 such that the processor 202 can read information from, and write information to, the memory 204. In the alternative, the memory 204 may be integral to the processor 202. As an example, the processor 202 and the memory 204 may reside in a suitably designed ASIC.

The network interface 206 is compatible with, and is coupled to, the data communication network 106 (see FIG. 1). The network interface 206 is configured to receive signals, data, packets, messages, or information in any suitable format from the remote user device(s) 114, and to send signals, data, packets, messages, or information in any suitable format to the remote user device(s) 114, via the data communication network 106. Thus, the network interface 206 supports one or more data communication protocols, specifications, standards, techniques, and/or methodologies used by the data communication network 106 for purposes of data transmission. In particular embodiments, the network interface 206 is compatible with packet switched network technology and is capable of supporting Voice Over Internet Protocol techniques and methodologies. It should be appreciated that the network interface 206 can be realized using hardware, software, firmware, and/or processing logic, and that the network interface 206 may leverage conventional design concepts that need not be described in detail here.

The telecommunication service interface 208 is compatible with, and is coupled to, the local telecommunication network 104. The telecommunication service interface 208 is suitably configured to receive signals, data, packets, messages, or information in any suitable format from sources in or coupled to the local telecommunication network 104, and to provide signals, data, packets, messages, or information in any suitable format to the local telecommunication network 104. In certain implementations, the system handles packetized data streams over different hardware/physical layers such as GSM, 3G, 4G, Wi-Fi, Ethernet, WiMax, USB, Bluetooth, or the like. Thus, the telecommunication service interface 208 supports one or more data communication protocols, specifications, standards, techniques, and/or methodologies used by the local telecommunication network 104 for purposes of handling telecommunication messages (e.g., V5 interface telephone network protocols). In particular embodiments, the telecommunication service interface 208 is compatible with PSTN technology. It should be appreciated that the telecommunication service interface 208 can be realized using hardware, software, firmware, and/or processing logic, and that the telecommunication service interface 208 may leverage conventional design concepts that need not be described in detail here.

The data network conversion module 210 is configured to convert or transform local telecommunication signals received by the telecommunication service interface 208 into a different format that is compatible with the data communication network 106. Conversely, the telecom network conversion module 212 is configured to convert or transform remote network data received by the network interface 206 into a different format that is compatible with the telecommunication network 104. In certain embodiments, the data network conversion module 210 converts local telephone voice signals (provided by the telecommunication network 104) into a Voice Over Internet Protocol format that is suitable for packet based transmission over the data communication network 106. For such embodiments, the telecom network conversion module 212 transforms Voice Over Internet Protocol data packets (provided by the data communication network 106) into a voice signal format that is suitable for transmission over the local telecommunication network 104.

Depending upon the particular implementation, the data network conversion module 210 and the telecom network conversion module 212 could be realized as separate elements or modules, or they could be realized as a single codec module, a single transcoder module, or the like. Moreover, the data network conversion module 210 and the telecom network conversion module 212 can be realized using hardware, software, firmware, and/or processing logic, and these modules may leverage conventional design concepts that need not be described in detail here.

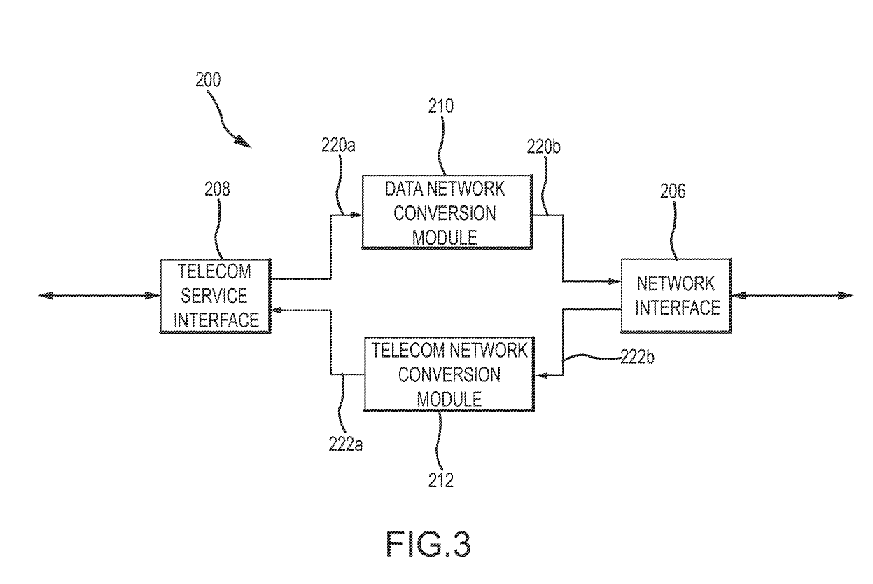

FIG. 3 is a schematic functional representation of the place-shifting apparatus 200. FIG. 3 illustrates how the data network conversion module 210 might be coupled between the telecommunication service interface 208 and the network interface 206, and how the telecom network conversion module 212 might be coupled between the network interface 206 and the telecommunication service interface 208. Using this arrangement, the data network conversion module 210 can be used to process telecommunication messages 220 destined for the remote user device(s) 114, and the telecom network conversion module 212 can be used to process telecommunication messages 222 that originate at the remote user device(s) 114. In FIG. 3, the telecommunication messages 220a and 222a are formatted for transmission compatibility with the local telecommunication network 104, while the telecommunication messages 220b and 222b are formatted for transmission compatibility with the data communication network 106. FIG. 1 depicts how the place-shifting device 102 can be used to establish and maintain a communication link 120 between the local telecommunication network 104 and the data communication network 106 for purposes of place-shifting telecommunication messages from the location 108 to the remote user device(s) 114. Referring to FIG. 3, this communication link 120 may utilize the processing path through the data network conversion module 210 and/or the processing path through the telecom network conversion module 212.

The telecommunication messages carried by the local telecommunication network 104 may be conveyed in an analog or digital, manner. In other words, traditional analog telephony or modem digital telephony techniques and technologies may be supported. Consequently, the place-shifting apparatus 200 may be suitably configured to handle analog telecommunication messages and/or digital telecommunication messages, depending upon the particular embodiment. In this regard, the data network conversion module 210 and the telecom network conversion module 212 could be designed to perform additional processing or to cooperate with other functional modules (not shown in FIG. 2) that contemplate analog or digital telephony.

For an analog telephony embodiment, the telephone signals received from the local telecommunication network 104 would be converted into digital signals (this analog-to-digital conversion could be performed by the telecommunication service interface 208 or the data network conversion module 210), and then packetized and encoded for transmission using the data communication network 106. In the reverse direction, packets received from the data communication network 106 would be decoded and then converted into an analog signal form for transmission via the local telecommunication network 104.

For a digital telephony implementation, the voice content provided by the local telecommunication network 104 is digitized and encoded in an appropriate format. Thus, the digital signals received from the local telecommunication network 104 would be decoded (by the telecommunication service interface 208 or the data network conversion module 210) to obtain the content. Thereafter, the content would be re-encoded or otherwise converted into a format suitable for transmission over the data communication network 106. In the reverse direction, packets received from the data communication network 106 would be decoded to obtain the content, and then the content would be re-encoded into a digital format suitable for the local telecommunication network 104.

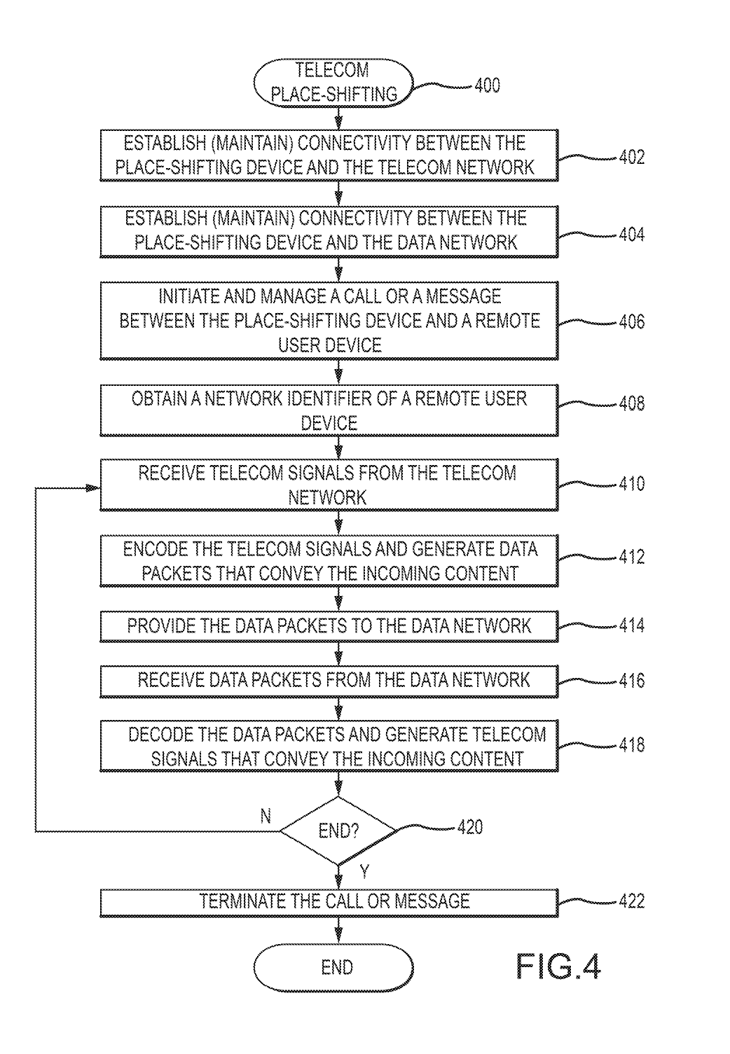

FIG. 4 is a flow chart that illustrates an exemplary embodiment of a telecommunication place-shifting process 400, which may be performed by the place-shifting system 100. The various tasks performed in connection with process 400 may be performed by software, hardware, firmware, or any combination thereof. For illustrative purposes, the following description of process 400 may refer to elements mentioned above in connection with FIGS. 1-3. In practice, portions of process 400 may be performed by different elements of the described system, e.g., the place-shifting device, a remote user device, a data communication interface, or the like. It should be appreciated that process 400 may include any number of additional or alternative tasks, the tasks shown in FIG. 4 need not be performed in the illustrated order, and process 400 may be incorporated into a more comprehensive procedure or process having additional functionality not described in detail herein. Moreover, one or more of the tasks shown in FIG. 4 could be omitted from an embodiment of the process 400 as long as the intended overall functionality remains intact.

The example illustrated in FIG. 4 assumes that a place-shifting device facilitates communication between the local telecommunication network and at least one remote user device. To this end, the process 400 may establish and maintain connectivity and communication between the place-shifting device and the local telecommunication network (task 402), and establish and maintain data connectivity and communication between the place-shifting device and the data communication network (task 404). The process 400 also assumes that at least one remote user device is in data communication with the same data communication network. These connections may be maintained in a persistent manner while the user desires place-shifting of telecommunication messages, telephone calls, etc. If the user returns to the location 108 and it becomes convenient to use the traditional landline telephone number again, then these connections can be torn down or disabled if so desired.

The process 400 assumes that the place-shifting device will be used to initiate, manage, or otherwise handle a call or a telecommunication message between the place-shifting device and a remote user device (task 406). In practice, task 406 may be associated with an incoming telephone call on the user's traditional landline telephone number, or it may be associated with a telephone call that has been initiated at the remote user device. Task 406 could also be associated with a one-way telecommunication message (e.g., an email, a text message, a file download, or the like) that is place-shifted to the remote user device. The following example relates to the handling of a two-way telephone call that is initiated by a calling party dialing the user's traditional landline telephone number. For this example, the process 400 place-shifts the incoming telephone call such that the user can answer the call using the remote user device.

When handling an incoming call, the place-shifting device may access or otherwise obtain a network identifier of the remote user device (task 408). The network identifier is used to identify the remote user device within the data communication network 106 to which the place-shifting device is connected. In practice, the network identifier could be, without limitation: an Internet Protocol (IP) address; a Media Access Control (MAC) address; an identifier for a mobile telephone or computing device; or the like. It should be appreciated that the place-shifting device may be suitably configured to store a list of different network identifiers corresponding to a plurality of different remote user devices (the user could designate which remote user device or which network address to use for a given place-shifting period of time). The network identifier can be used to route data to the designated remote user device. In this regard, the network identifier provides routing guidance for place-shifted telecommunication messages.

To support a place-shifted call or message, the place-shifting device receives telecommunication (telephone) signals from the local telecommunication network 104 (task 410). The telephone signals may include analog signals or digital signals, in various embodiments. As explained previously, these incoming telecommunication signals may be associated with any calling party device, calling party telephone number, component, server, processing logic, or other information source. The telecommunication signals (more specifically, the telecommunication message conveyed by the telecommunication signals) received at the place-shifting device are processed in an appropriate manner for transmission compatibility with the data communication network 106 (task 412). For this particular embodiment, task 412 represents a conversion from the traditional landline telephone signal format and communication protocol into a different format that is appropriate for transmission using a packet switched network. In an analog embodiment, the conversion includes performing an analog-to-digital conversion, and packetizing and encoding the resulting digital content into the data network format. In a digital implementation, the conversion includes decoding the telecom signal to obtain the digital content, possibly repacketizing the digital content, and encoding the digital content into the data network format. In this regard, the process 400 may generate suitably formatted data packets that convey the same incoming content that is conveyed in the received telecommunication signals. For voice calls, the traditional landline telephone signals are encoded such that the data packets convey the same voice content of the original telephone signals. In particular embodiments, task 412 may encode the incoming telecommunication signal content into a Voice Over Internet Protocol format. The place-shifting device provides the encoded data packets to the data communication network 106 (task 414), using the network identifier of the remote user device for routing guidance. This allows the encoded data packets to be transmitted to the remote user device in accordance with Voice Over Internet Protocol techniques and methodologies.

For this two-way voice call example, the place-shifting device receives “reply” or “answer” data packets from the data communication network 106 (task 416). These received data packets may be generated or initiated by the remote user device, and these data packets may represent a reply message, voice content, or the like. The reply data packets are typically generated in response to the encoded telecommunication message being received, processed, and presented at the remote user device. The place-shifting device processes the received data packets in an appropriate manner for transmission compatibility with the local telecommunication network 104 (task 418). For this particular embodiment, task 418 represents a conversion from the packet switched network format and communication protocol into a different format that is appropriate for transmission using the local telecommunication network (e.g., the PSTN). In an analog embodiment, the conversion includes decoding the signal received from the data network to obtain the digital content, and performing a digital-to-analog conversion to generate an analog signal for the telecom network. In a digital embodiment, the conversion includes decoding the data network signal to obtain the digital content, possibly repacketizing the digital content, and encoding the digital content into the telecom network format. In this regard, the process 400 may generate suitably formatted telecommunication signals that convey the same content that is provided in the received data packets. For voice calls, task 418 decodes voice-conveying data (received in data packet format) into a format that is appropriate for transmission over the traditional landline telephone connection. The place-shifting device provides the decoded telecommunication signals to the telecommunication network 104, which directs the signals to the other party using well known techniques and technologies.

It should be appreciated that some of the tasks 412, 414, 416, and 418 may be performed in any order or in parallel, and that tasks 412 and 414 could be performed multiple times in a row independently of tasks 416 and 418 (and vice versa). For example, if only one party is speaking for an extended period of time, then the two-way call will be processed as a one-way call for that period of time.

If the current call or message has ended (query task 420), then the process 400 will terminate the call or message (task 422) and tear down the communication link between the remote user device 114 and the calling party. If the current call or message has not ended, then the process 400 continues to receive the telecommunication network signals and/or the data network packets, and continues to perform encoding and/or decoding as needed to support the place-shifting of the call.

The above description relates to a typical scenario where the place-shifting system 100 place-shifts calls associated with a traditional landline telephone number. The place-shifting techniques and methodologies described above could also be utilized to place-shift calls associated with other devices, components, or applications. For example, the place-shifting device 102 could be suitably configured to place-shift calls directed to or originating from a cellular telephone or other mobile device. In this scenario, the place-shifting device 102 could be designed to communicate with the mobile device via a short-range wireless link, a tangible cable or docking station, or the like. With such an architecture in place, the user could place-shift calls between a mobile device (that remains at the stationary location 108) and one or more remote user devices 114.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of place-shifting telecommunication messages, the method comprising:
receiving an incoming telecommunication message at a place-shifting device;
encoding the incoming telecommunication message for transmission compatibility with a data communication network, resulting in an encoded telecommunication message;
obtaining a network identifier of a remote user device; and
providing the encoded telecommunication message to the data communication network, using the network identifier for routing guidance.

2. The method of claim 1, wherein the incoming telecommunication message comprises a message type selected from the group consisting of: a voice call; an email; a text message; an image-containing message; a video-containing message; an instant message; and a videoconference call.

3. The method of claim 1, wherein:
receiving the incoming telecommunication message comprises receiving a voice call from the public switched telephone network; and
encoding the incoming telecommunication message comprises encoding the voice call for transmission using a packet switched network.

4. The method of claim 3, wherein providing the encoded telecommunication message comprises transmitting in accordance with Voice Over Internet Protocol techniques.

5. The method of claim 1, wherein the remote user device comprises a device type selected from the group consisting of: a wireless telephone; a network telephone; a portable computer; a desktop computer; a personal digital assistant; a digital media player; a video game system; a remote control device; a medical device; a vehicle-based communication, navigation, or entertainment system; and audiovisual equipment.

6. The method of claim 1, further comprising:
receiving, from the remote user device and via the data communication network, a reply message generated by the remote user device in response to the encoded telecommunication message;
decoding the reply message for transmission compatibility with a telecommunication network, resulting in a decoded reply message; and
providing the decoded reply message to the telecommunication network.

7. The method of claim 6, wherein the incoming telecommunication message and the reply message are associated with a two-way telephone call.

8. A method of place-shifting telephone calls that involve a traditional landline telephone number, the method comprising:
maintaining, with a place-shifting device residing at a location associated with the traditional landline telephone number, a communication link between a local telephone network and a data communication network, the local telephone network supporting service for the traditional landline telephone number, and the data communication network providing data connectivity with a remote user device;
for communication from the local telephone network to the remote user device, converting telephone signals into a first format compatible with transmission over the data communication network, wherein converting into the first format is performed by the place-shifting device; and
for communication from the remote user device to the local telephone network, converting voice-conveying data into a second format compatible with transmission over the local telephone network, wherein converting into the second format is performed by the place-shifting device.

9. The method of claim 8, wherein converting telephone signals comprises generating data packets that convey voice content of the telephone signals.

10. The method of claim 8, wherein converting telephone signals is performed in a manner that is compliant with a packet switched network.

11. The method of claim 8, wherein converting telephone signals results in encoded telephone signals, and wherein the method further comprises providing the encoded telephone signals to the data communication network.

12. The method of claim 11, wherein providing the encoded telephone signals comprises transmitting in accordance with Voice Over Internet Protocol techniques.

13. The method of claim 8, wherein converting voice-conveying data comprises converting data packets into voice signals suitable for transmission over the local telephone network.

14. The method of claim 13, further comprising providing the voice signals to the local telephone network.

15. The method of claim 8, further comprising:
establishing data connectivity between the place-shifting device and the remote user device using a packet switched network; and
establishing communication between the place-shifting device and a public switched telephone network, wherein the maintaining step maintains the communication link between the public switched telephone network and the packet switched network.

16. The method of claim 15, wherein the packet switched network comprises a wide area network.

17. An apparatus for place-shifting telecommunication messages, the apparatus comprising:
a telecommunication service interface compatible with a telecommunication network that provides telecommunication service to the apparatus;
a network interface compatible with a data communication network that provides data connectivity between the apparatus and a remote user device;
a data network conversion module coupled between the telecommunication service interface and the network interface, the data network conversion module being configured to convert local telecommunication signals received by the telecommunication service interface into a first format compatible with the data communication network; and
a telecom network conversion module coupled between the network interface and the telecommunication service interface, the telecom network conversion module being configured to transform remote network data received by the network interface into a second format compatible with the telecommunication network.

18. The apparatus of claim 17, wherein the apparatus is integrally implemented in a video services receiver system.

19. The apparatus of claim 17, wherein:
the telecommunication network includes a public switched telephone network;
the data communication network includes a packet switched network;
the data network conversion module is configured to convert local telephone voice signals into a Voice Over Internet Protocol format; and
the telecom network conversion module is configured to transform Voice Over Internet Protocol data packets into a voice signal format.

20. The apparatus of claim 17, wherein the local telecommunication signals convey a message type selected from the group consisting of: a voice call; an email; a text message; an image-containing message; a video-containing message; an instant message; and a videoconference call.
